(19) United States
(12) Patent Application Publication
(10) Pub. No.: US 2013/0275858 A1
(43) Pub. Date: Oct. 17, 2013

(54) INFORMATION PROCESSING DEVICE

(71) Applicant: PANASONIC CORPORATION, Osaka (JP)

(72) Inventors: Yuichiro MIYAMOTO, Osaka (JP); Shinichi YAMAMOTO, Osaka (JP)

(73) Assignee: PANASONIC CORPORATION, Osaka (JP)

(21) Appl. No.: 13/794,986

(22) Filed: Mar. 12, 2013

(30) Foreign Application Priority Data
Apr. 17, 2012 (JP) 2012-093623

(51) Int. Cl. G06F 17/24

(52) U.S. Cl. CPC G06F 17/24
USPC 715/234

(57) ABSTRACT

An information processing device 10 acquires first and second document information distributed through a network and causes the first and second document information to be displayed on a display screen. The second document information is distributed after the first document information. The device 10 includes: a network interface 11 configured to perform communication of information via the network; and a controller 16 configured to cause the first and second document information to be displayed on the display screen. The controller 16 accepts, while the first document information is being displayed, from the user a selection of partial information contained in the first document information. The controller 16 causes, while the subsequently-distributed second document information is being displayed, information within the second document information related to the selected partial information, to be displayed in a mode of displaying different from that of any other information within the second document information.

### BACKGROUND

1. Technical Field

The present disclosure relates to an information processing device which is capable of changing the mode of displaying a content according to the interests of a user.

2. Description of the Related Art

A technology for displaying newspaper image data, which is received via a communication line and represents actual pages of newspaper, on a display screen of a personal computer (PC) or the like is described in, for example,

Japanese Laid-Open Patent Publication No. 2007-323369.

There is also a technology for allowing newspaper provided in paper to be viewed as an electronic version of the newspaper by a terminal such as a smartphone or the like (hereinafter, referred to as an “information processing device”). A user can have an image of a page of the newspaper displayed on the display of the information processing device or browse latest news (hereinafter, referred to also as “breaking news”) by installing a newspaper application onto the information processing device. By use of such an information processing device, the user can read newspaper or breaking news conveniently outside his/her home, for example, on his/her way to work or school.

### SUMMARY

A user may become interested in the information within a given electronic document such as a newspaper, a book, .a magazine, or a journal, and wish to further read into the details of the information of interest or read some related articles. In such cases, under the conventional techniques, there is a need to search for the relevant information (such as an article) from within a subsequently-distributed electronic document, which presents a problem of inconvenience to the user. In certain cases, it may not be possible to find any detailed articles or related information concerning the information of interest, thus being unable to read further.

One non-limiting, and exemplary embodiment of the present disclosure provides an information processing device, system, and computer program which, in order to reduce the burden of having to look for a detailed article or related information, adopts a mode of displaying a document content which is different from a usual mode of displaying.

In one general aspect, an information processing device according to an embodiment of the present disclosure acquires first document information which is distributed through a network and second document information which is distributed after the first document information, and displays the first and second document information on a display screen. The information processing device includes a network interface for handling communication of information via the network and a controller for causing the first and second document information acquired by the network interface to be displayed on the display screen. The controller is arranged so as to, while the first document information is being displayed on the display screen, accept from the user a selection of partial information that is contained in the first document information, and while the subsequently-distributed second document information is being displayed on the display screen, cause information within the second document information that is related to the selected partial information to be displayed in a mode of displaying different from that of any other information within the second document information.

With the technique of the present disclosure, a document content that is related to information which a user finds interesting can be displayed in a mode of displaying different from that of any other document content. This reduces the burden of the user in locating information that is related to the information of interest.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is an overall configuration diagram of an electronic newspaper display system according to Embodiment 1, which is illustrative.

FIG. 2A is a diagram showing an instance of a breaking news list which is displayed on the display screen of an electronic newspaper display device.

FIG. 2B is a diagram showing an instance of an individual article that is displayed on the display screen of an electronic newspaper display device.

FIG. 2C is a diagram showing an instance of a headline list of an electronic newspaper that is displayed on the display screen of an electronic newspaper display device.

FIG. 2D is a diagram showing an instance of a newspaper image of an electronic newspaper that is displayed on the display screen of an electronic newspaper display device.

FIG. 3 is a flowchart showing an exemplary electronic newspaper displaying process of an electronic newspaper display system.

FIG. 4 is diagram showing an exemplary displayed image of breaking news list after a specific news item has been selected by a user.

FIG. 5 is a diagram showing an exemplary document structure of an HTML document.

FIG. 6 is a diagram showing an example of correspondence information which is generated by a controller 16.

FIG. 7 is a diagram showing an exemplary displayed image after a change is made in the mode of displaying a headline list of an electronic newspaper.

FIG. 8A is a diagram showing an exemplary displayed image after a change is made in the mode of displaying a newspaper image of an electronic newspaper.

FIG. 8B is a diagram showing another exemplary displayed image after a change is made in the mode of displaying a newspaper image of an electronic newspaper.

FIG. 8C is a diagram showing another exemplary displayed image after a change is made in the mode of displaying a newspaper image of an electronic newspaper.

FIG. 9 is a flowchart showing another example of an electronic newspaper displaying process of an electronic newspaper display device.

FIG. 10 is an overall configuration diagram showing an information provision system which provides information on matters which are of interest to a user.

FIG. 11 is a flowchart showing an exemplary operation of an information provision system.

FIG. 12 is a diagram showing an instance where suggested information is displayed on an information processing device, together with a newspaper content.

### DETAILED DESCRIPTION

Embodiments will now be described in detail, referring to the drawings. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims.

### Embodiment 1

Now, a first embodiment will be described. The present embodiment relates to an electronic newspaper display system including an information processing device which is capable of displaying a content of an electronic newspaper (which hereinafter may be referred to as a “newspaper content”) on a display screen.

[1-1. Constitution]

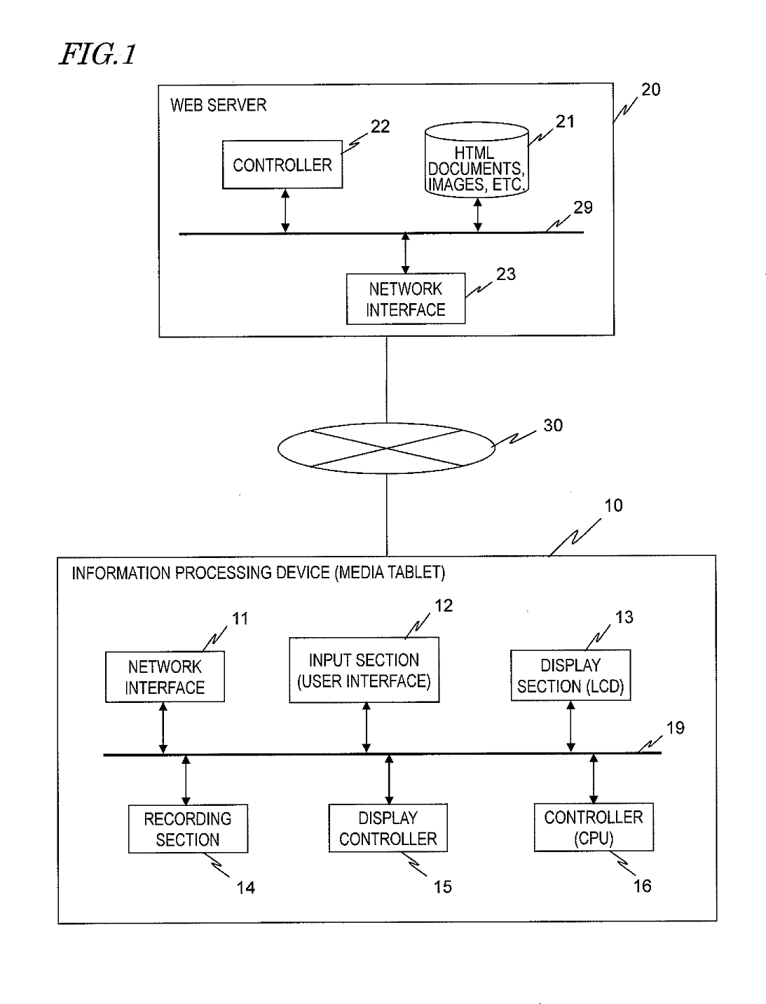

FIG. 1 is a diagram showing an overall configuration of an electronic newspaper display system according to the present embodiment. This system includes a web server 20 and an information processing device (media tablet) 10, which are interconnected via a network 30 so as to be capable of communications between each other. As an electronic document, an electronic newspaper content is distributed from the web server 20 to the information processing device 10 in the present embodiment. Although FIG. 1 shows only one information processing device 10, it is typical for a content of the same substance to be distributed to a plurality of information processing devices from the web server 20.

The web server 20 is a computer which is managed by an information distribution entity such as a newspaper company, for example. The web server 20 includes a recording section 21 in which distributed contents are recorded, a network interface 23 which performs communications via the network 30, and a controller 22 which controls the overall operation of the web server 20. These sections are interconnected via a bus 29 so as to be capable of mutual exchange of electrical signals. The web server 20 may include other constituent elements not shown in FIG. 1.

The recording section 21 is a recording device such as a hard disk drive (HDD), for example. In the recording section 21, data of newspaper contents and breaking news waiting to be distributed are stored. The network interface 23, which may be a known network adapter, exchanges information between itself and the information processing device 10. The controller 22, which may include a CPU (Central Processing Unit), a graphics controller, and other integrated circuitry, performs a content distribution process (described later) in accordance with a computer program that is stored in a memory not shown. Note that the controller 22 may be composed only of hardware, e.g., specially-designed semiconductor integrated circuitry.

To the information processing device 10, the controller 22 of the web server 20 distributes breaking news information on an irregular basis, and also distributes at regular intervals a newspaper content such as a morning edition or an evening edition. These newspaper contents may contain data of HTML documents and images. Such data are daily generated by a newspaper company or the like, and accumulated in the recording section 21. In accordance with a request from the information processing device 10 having a web browser, the controller 22 distributes breaking news and newspaper contents.

The information processing device according to the present embodiment (also referred to as the “electronic newspaper display device”) 10 is a user terminal, e.g., a PC (personal computer) or a smartphone, that is capable of displaying breaking news (also referred to as a “newly-arrived article”) and a newspaper content to be distributed after the arrival of that breaking news; herein, the information processing device 10 is assumed to be a media tablet. The newspaper content to be displayed may include information of a headline list, a newspaper image, or the like, as will be described later.

The media tablet 10 includes: a network interface which performs communications via a network; an input section (user interface) 12 which accepts various manipulations by a user, e.g., tap manipulations and input manipulations; a display section 13 which displays text of breaking news and/or an image of a newspaper image, etc., on a display screen using a LCD (liquid crystal display) or the like; a recording section 14 which records the text data of the breaking news or the image data of the newspaper image, etc., to be displayed; a display controller 15 which controls displaying on the display section 13; and a controller 16 which controls operations of these sections. These sections are connected so as to be capable of mutual exchange of electrical signals via a bus 19.

The network interface 11, which may be a known network adapter, perform communication, i.e., exchange of information between itself and the web server 20. The input section 12, which is a user interface including a touch sensor, hardware buttons, and the like, accepts manipulations made by a user. The display section 13, which is a display such as an LCD, displays a content based on an instruction from the display controller 15. The recording section 14, which is a recording device such as a HDD, records data of a content that has been distributed from the web server 20, as well as various data which occurs during the processing. The display controller 15, which is composed of e.g. a general-purpose graphics controller, causes the display section 13 to display an image in accordance with an instruction from the controller 16. The controller 16, which is a processor (e.g., a CPU), controls the entire media tablet 10 in accordance with a program which is stored in a memory not shown. In the present embodiment, the controller 16 is implemented as a CPU executing a program which is stored in the recording section 14; however, it may be implemented in hardware such as a specially-designed integrated circuit. Moreover, functional blocks including the controller 16 and the display controller 15 may be implemented in a single integrated piece of hardware such as an integrated circuit.

Note that the configuration shown in FIG. 1 is exemplary; so long as the controller 16 of the media tablet 10 and the controller 22 of the web server 20 are capable of executing the operations described below, their configurations may be arbitrary. For example, any constituent element not shown in FIG. 1 may be added, and some of the constituent elements shown in FIG. 1 may be replaced by other appropriate elements.

While a list of breaking news is being displayed, if the user takes interest in a given breaking news, the controller 16 performs a process of registering that breaking news, and generates correspondence information indicative of the correspondence between the registered breaking news and a specific article in a newspaper content to be distributed after the arrival of that breaking news. Based on this correspondence information, the display controller 15 causes the article of a newspaper content that corresponds or is related to the breaking news having been registered by the user to be displayed in a different mode of displaying from that of the other articles in the newspaper content.

The text data of breaking news or the image data of a newspaper image, etc., to be displayed are distributed via a communications network 30 (such as a public wireless LAN provided as a service or the Internet) from the recording section 21 of the web server 20. The distributed data is received by the network interface 11, and recorded in the recording section 14. Thereafter, in response to a manipulation by the user which is made via the input section 12, the process is passed to the controller 16. In accordance with an instruction from the controller 16, the display controller 15 causes the text of the breaking news and/or the image of the newspaper image to be displayed on the display screen of the display section 13, by means of a web browser.

The media tablet 10 has a “breaking news list displaying mode” for displaying a breaking news list, a “breaking news detail displaying mode” for displaying the details of breaking news, a “headline list displaying mode” for displaying a headline list of an electronic newspaper such as an morning edition or an evening edition, and a “newspaper image displaying mode” for displaying a newspaper image of an electronic newspaper. The user is able to switch between the displaying modes by using a dedicated button(s) that is included in the input section 12 or a specific place(s) (a button indication(s) or the like) on the display screen.

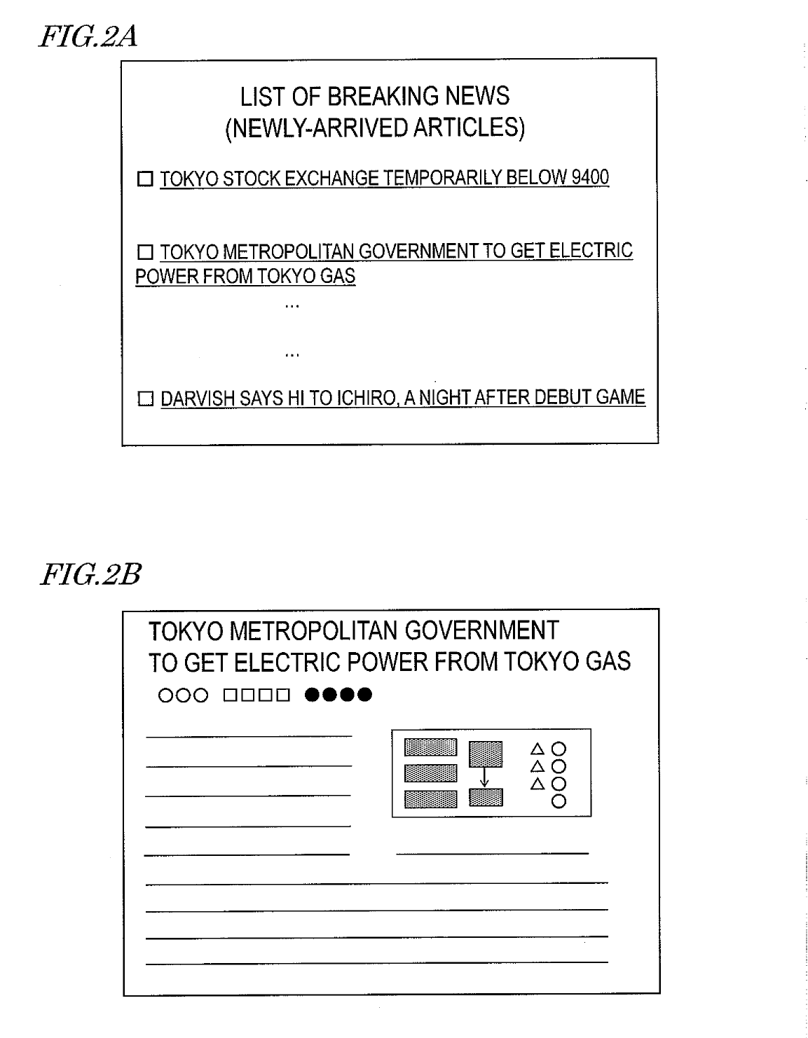

The “breaking news list displaying mode” is a mode in which a list of breaking news that are distributed from the web server 20 on an irregular basis is displayed. In the breaking news list displaying mode, a screen shown in FIG. 2A may be displayed on the display section 13, for example. In this screen, headings of the articles pertaining to the breaking news are displayed.

The “breaking news detail displaying mode” is a mode in which the detailed substance of an individual news item in the breaking news list is displayed. When the user selects the heading of a desired article (through a tap or click) in the breaking news list displaying mode, a transition to the breaking news detail displaying mode occurs. FIG. 2B is a diagram showing an exemplary display screen in the breaking news detail displaying mode. The exemplary screen here illustrates a case where an article with the heading “TOKYO METROPOLITAN GOVERNMENT TO GET ELECTRIC POWER FROM TOKYO GAS” has been selected. As a result, the user is able to read a detailed article pertaining to the selected heading.

The “headline list displaying mode” is a mode in which a list of headlines of a morning edition or an evening edition is displayed. This mode is adopted after the content of the morning edition or evening edition is distributed from the web server 20. In the headline list displaying mode, a screen shown in FIG. 2C may be displayed, for example. The substance displayed therein appears similar to the substance displayed under the breaking news list displaying mode, except that the headings displayed here do not belong to the breaking news, but to the news which are carried in the morning edition or evening edition. Note also that while checkboxes are indicated at the left of the article headings in the screen of FIG. 2A, no checkboxes are indicated in the screen of FIG. 2C.

The “newspaper image displaying mode” is a mode in which an actual page image of a morning edition or an evening edition is displayed. In the newspaper image displaying mode, a screen with the entirely same layout as that of an actual newspaper is displayed, as shown in FIG. 2D, for example. This mode may be adopted when an indication of a switching button not shown in FIG. 2C is tapped by the user in the headline list displaying mode, for example.

Note that the controller 16 may be arranged so that, when an individual heading is selected in the screen shown in FIG. 2C, a transition to a screen of the detailed article as shown in FIG. 2B occurs. Each screen structure illustrated above is only exemplary; any screen structure other than these may also be adopted.

[1-2. Operation]

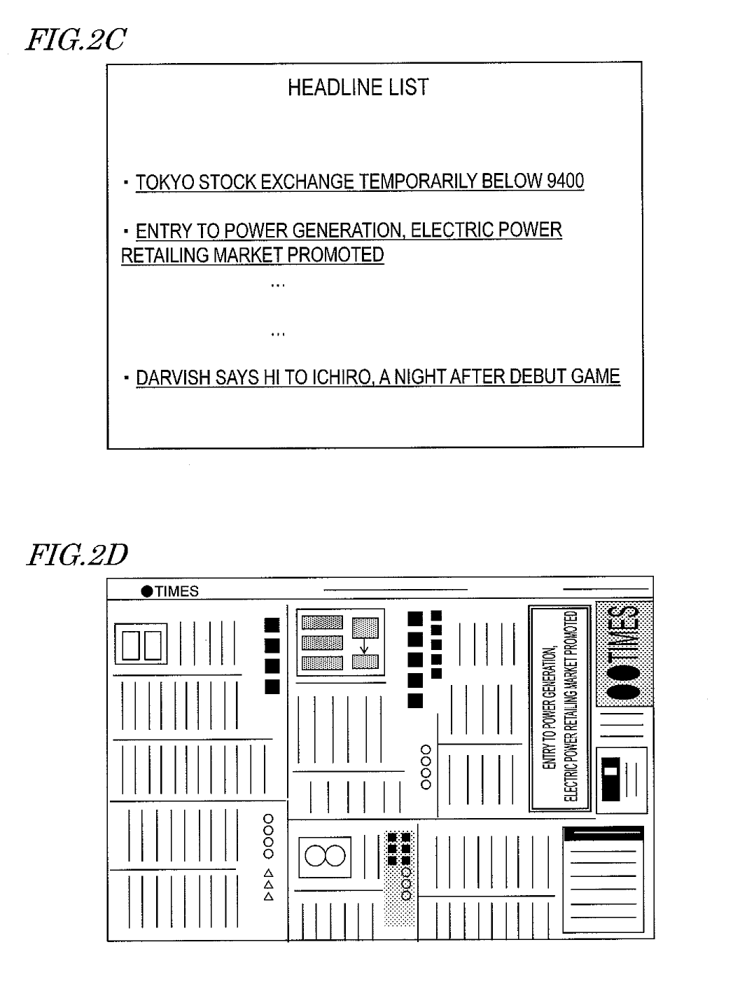

Next, an electronic newspaper displaying method on the media tablet 10 will be described. FIG. 3 is a flowchart showing a flow of processes for displaying an electronic newspaper with the media tablet 10 and the web server 20.

At step S300, the media tablet 10 requests the web server 20 to distribute breaking news. Specifically, via the network interface 11, the controller 16 of the media tablet 10 sends to the web server 20 a piece of information for requesting breaking news. Upon receiving the request for distribution at step S301, the web server 20 distributes the requested breaking news to the media tablet 10 at step S302. Next, at step S310, the network interface 11 of the media tablet 10 receives the breaking news which have been sent from the web server 20.

At the next step S320, the controller 16 and the display controller 15 of the media tablet 10 cause a list of breaking news as shown in FIG. 2A to be displayed on the screen of the display section 13. This allows the user to view the news individually, and possibly register (i.e., select) a news item of interest.

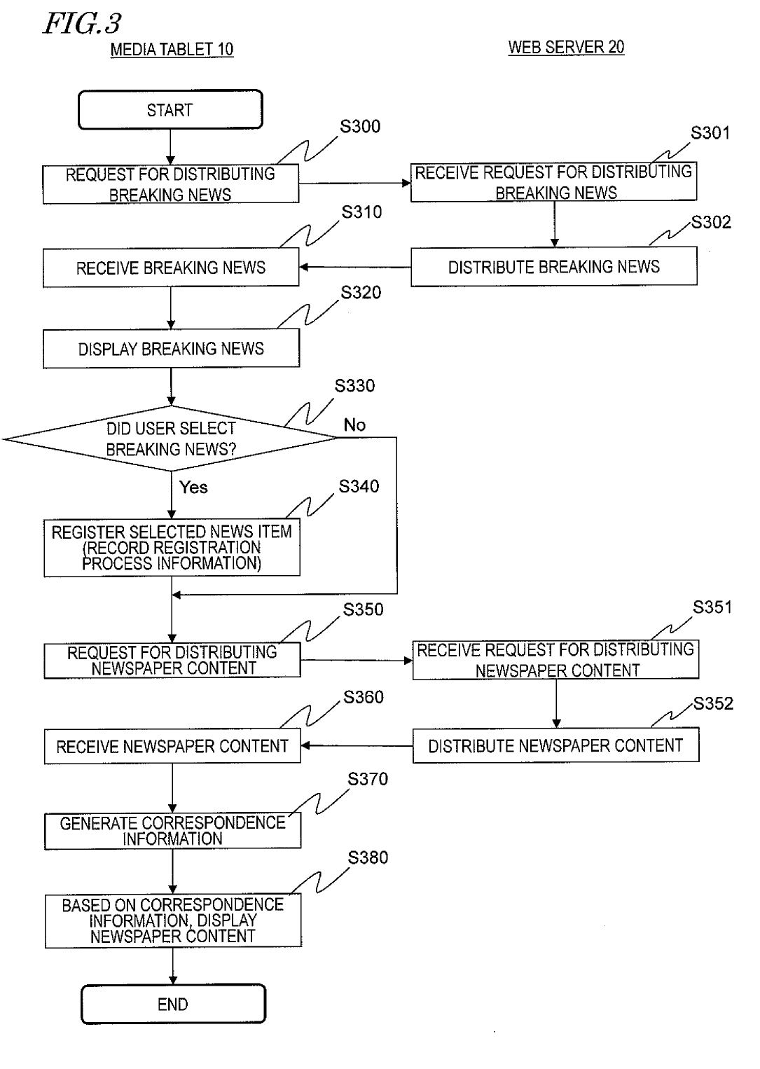

FIG. 4 is diagram showing an exemplary displayed image of a breaking news list after a specific news item has been selected by a user. If the user takes interest in an article, a box 40 at the left end of a heading screen under the breaking news list displaying mode may be checked so that the article becomes registered. At step S330, the controller 16 detects whether this check operation has been conducted. At the next step 5340, the controller 15 causes information (e.g., an article ID) indicating the headline of interest to the user to be recorded to the recording section 14. In the example shown in FIG. 4, the box 40 for the heading “TOKYO METROPOLITAN GOVERNMENT TO GET ELECTRIC POWER FROM TOKYO GAS” is checked, indicative of the fact that the user is interested in this headline. In this case, information that is associated with an article pertaining to the selected heading “TOKYO METROPOLITAN GOVERNMENT TO GET ELECTRIC POWER FROM TOKYO GAS”, e.g., an article ID, is recorded in the recording section 14. In the following description, this article ID of the selected article or like information may be referred to as “registration process information”, and an operation of recording the registration process information may be referred to as the “registration process”. Without being limited to an article ID, the registration process information may be any information that identifies an article selected by the user.

After lapse of time, when it becomes possible to receive the content of a morning edition or an evening edition, the media tablet 10 is able to request that content to be distributed. The media tablet 10 may be arranged so as to make this request in response to a user manipulation, or at a fixed time every day.

At step S350, a request to distribute an electronic newspaper content such as a morning edition or an evening edition is made from the media tablet 10 to the web server 20. Specifically, via the network interface 11, the controller 16 sends to the web server 20 a piece of information for requesting distribution of a newspaper content. Upon receiving the request for distribution at step S351, the web server 20 distributes the requested newspaper content at step S352. At the next step S360, the media tablet 10 receives the distributed newspaper content.

Note that distribution of a newspaper content would be impossible unless an electronic newspaper waiting to be distributed after the arrival (serving) of breaking news existed in the web server 20. Usually, however, when a predetermined time has elapsed (e.g., a half day) after the arrival (serving) of breaking news, the newspaper company will have finished preparing an electronic newspaper content such as a morning edition or an evening edition that contains the substance of the breaking news. In that case, the HTML document, image, or other information constituting the newspaper content is stored in the recording section 21 of the web server 20, thus becoming ready to be distributed to the media tablet 10.

Therefore, the request for distributing a newspaper content at step S350 is to be made after the lapse of a predetermined time since the media tablet 10 receives the breaking news. This enables the media tablet 10 to receive an electronic newspaper content.

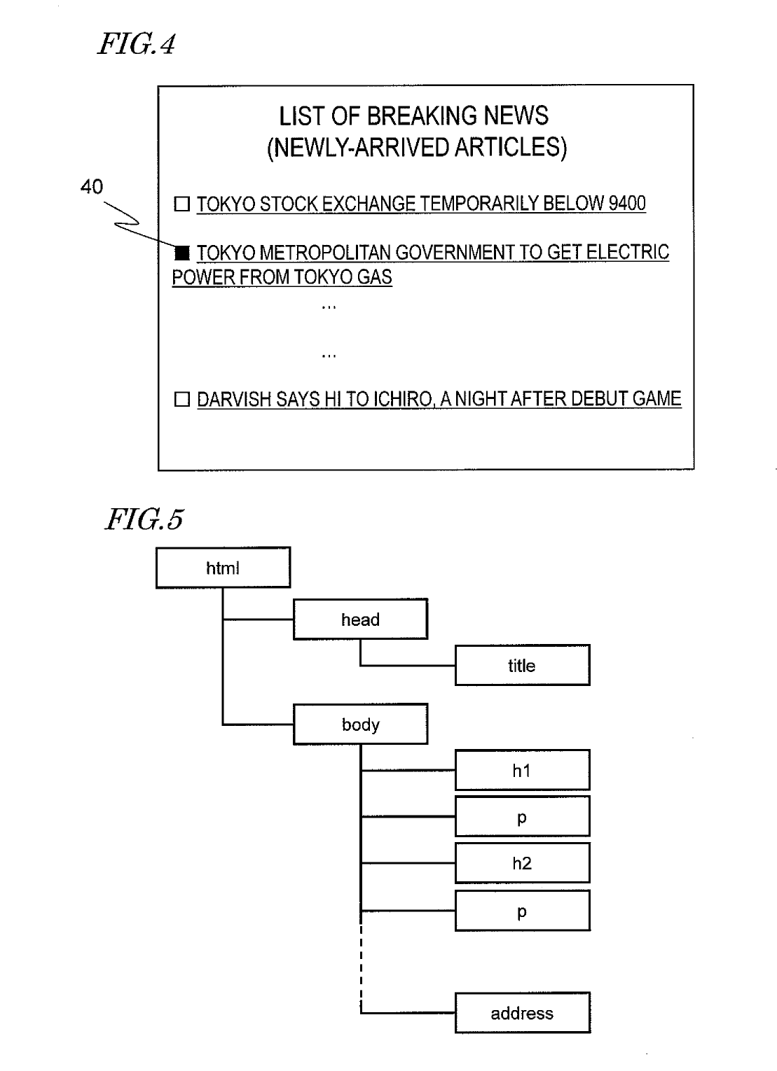

FIG. 5 shows an exemplary document structure of an HTML document composing an electronic newspaper. An HTML document composing an electronic newspaper, to be accumulated in the recording section 21 of the web server 20, may have a document structure as shown in the figure. An HTML document combines elements (parts) such as a title, headings, paragraphs, and so on. Under the HTML, an element may be indicated by sandwiching a portion of the document with special character strings called “tags”, each tag indicated in between “<” and “>”. HTML allows information concerning the structure and decorations of a piece of writing to be described as embedments within the document. Moreover, the title and the paragraphs within a piece of writing can be demarcated, and images, audios, and videos can also be embedded as parts of the document.

A browser on the media tablet 10 looks for tags within HTML data, and displays it with distinctions being made as to which portion defines a heading and which portion defines a paragraph. In the example of FIG. 5, the HTML element contains a head element and a body element, each of these elements further containing its internal element(s). In the case where the elements have such a relationship, an outer element is referred to as a “parent element”, and an element included therein is referred to as a “child element”. One document can be represented as having a tree structure which starts with the html element. More specifically, a parent element is branched into child elements, which are further branched into child elements thereof.

Therefore, an electronic newspaper can be constructed by using an HTML document. An electronic newspaper may also be constructed by using an XML document, or by way of any other language.

At the next step S370, the controller 16 of the media tablet 10 generates correspondence information indicating correspondence between the article ID of the breaking news which underwent the registration process at step S340 and each article within the electronic newspaper which is distributed after the arrival of the breaking news. For example, in the instance shown in FIG. 4, the controller 16 searches the distributed newspaper content for any article whose heading includes a keyword(s) that is identical or similar to “electric power”, because “electric power” is contained in the article heading “TOKYO METROPOLITAN GOVERNMENT TO GET ELECTRIC POWER FROM TOKYO GAS”, whose heading box 40 was checked; then, the controller 16 generates correspondence information indicating the results of the search. At this time, from among a large number of headings that may be contained in the received headline list of the electronic newspaper, the controller 16 searches for any article that has a heading containing the keyword “electric power”, which is associated with the article selected by the user, or a heading containing similar wording to “electric power”. For example, assuming that an article with the heading “ENTRY TO POWER GENERATION, ELECTRIC POWER RETAILING MARKET PROMOTED” has been retrieved, in which the keyword “electric power” is contained, then information concerning the article having the heading “ENTRY TO POWER GENERATION, ELECTRIC POWER RETAILING MARKET PROMOTED” will be described in the correspondence information.

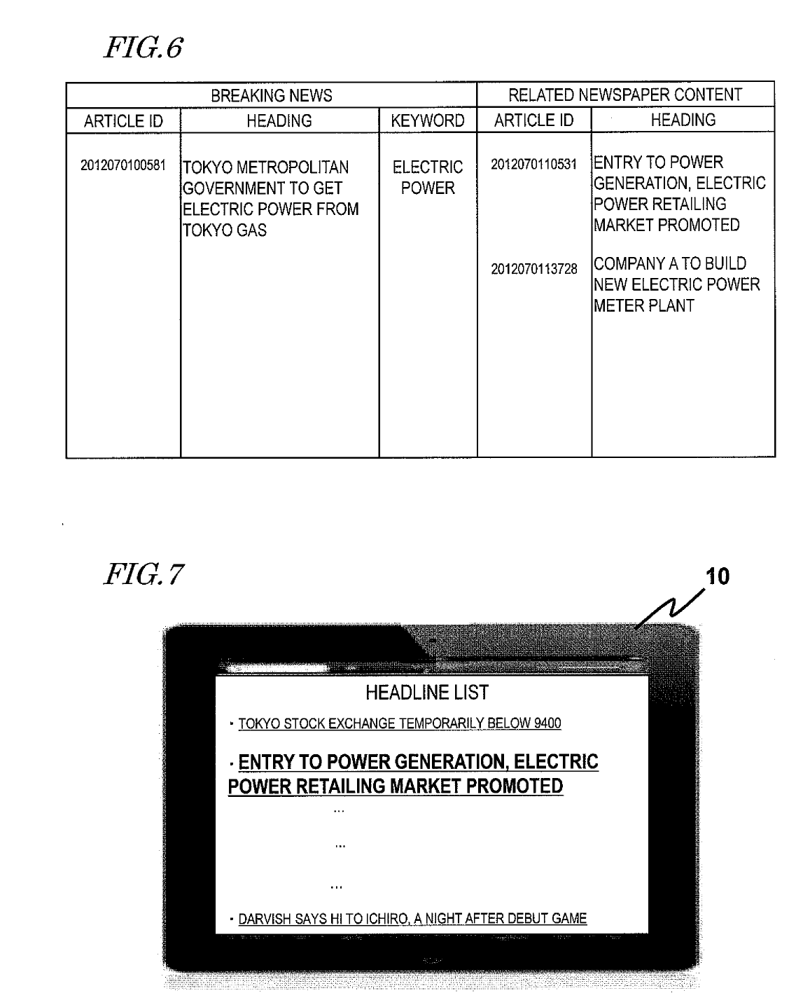

FIG. 6 is a diagram showing an example of correspondence information generated by the controller 16. In this example, the correspondence information contains information of the article ID, heading, and keyword of the breaking news selected by the user, as well as the article IDs and headings of related newspaper contents. In the example shown in FIG. 6, two articles have been retrieved whose headings contain the keyword “electric power” belonging to the breaking news selected by the user; therefore, the information of both articles is described in the correspondence information. Note that, if any article that contains similar wording to the keyword “electric power” in its heading has been retrieved, then the information of any such article will also be recorded in the correspondence information. The controller 16 generates such correspondence information, and records it to the recording section 14.

Without being limited to what is shown in FIG. 6, any correspondence information may be used that allows newspaper article information related to the article selected by the user to be recorded. For example, the correspondence information may be arranged to enable distinction between articles of the identical keyword and articles of similar keywords under management. Moreover, the correspondence information may be arranged so that a plurality of articles that have been retrieved are managed in order of similarity levels with the keyword. Furthermore, the aforementioned registration process information and the correspondence information may be constructed as one common table. For example, the information concerning the breaking news in the table shown in FIG. 6 may be utilized as registration process information, and this combined with information concerning the related newspaper contents may be utilized as correspondence information.

Thus, by conducting a search based on common or similar keywords between breaking news and newspaper contents, the controller 16 of the media tablet 10 is able to generate correspondence information indicating correspondence between registered breaking news information (article ID) and related articles within an electronic newspaper that is distributed after the arrival of the breaking news.

At step S380, based on the correspondence information generated at step S370, the controller 16 of the media tablet 10 causes the article of any newspaper content that is related (corresponding or similar) to the breaking news selected by the user to be displayed in a different mode of displaying from that of the other articles in the newspaper content. As used herein, a “corresponding” newspaper content means an article that completely matches the breaking news article selected by the user, whereas a “similar” newspaper content means an article which contains an identical or similar keyword but which is not completely matching.

As described above, when newspaper article information is described in the form of an HTML document, the controller 16 can change the style of the article by rewriting the HTML document. In an HTML document, it is easy to change the size and/or color of characters, as in the following manners.

<FONT SIZE=“+2”> THIS INCREASES SIZE OF CHARACTERS </FONT>

<FONT COLOR=“red”>THIS CHANGES COLOR OF CHARACTERS </FONT>

Therefore, through addition, modification, or deletion of such statements in the HTML document that corresponds to each article which is described in the correspondence information, the controller 16 is able to change the size, color, and the like of the characters in each article that is related to the breaking news selected by the user.

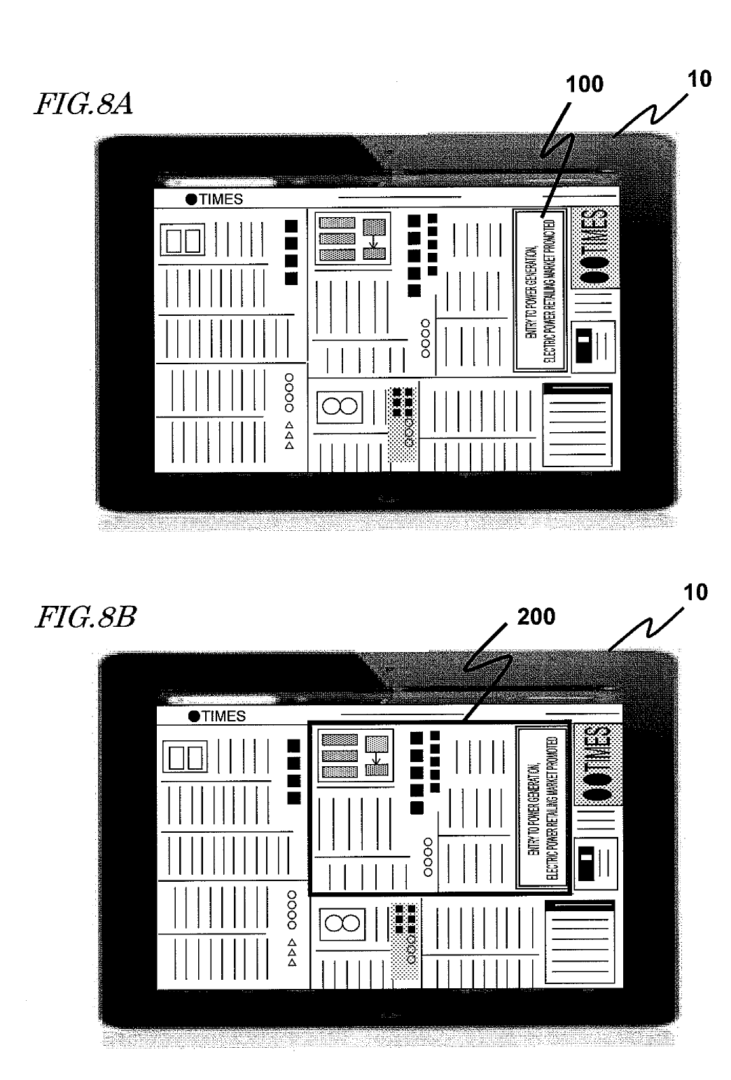

FIG. 7 is a diagram showing an exemplary displayed image after a change is made in the mode of displaying a headline list of an electronic newspaper on the display screen of the media tablet 10. In this example, the heading “ENTRY TO POWER GENERATION, ELECTRIC POWER RETAILING MARKET PROMOTED” in the headline list of an electronic newspaper under the headline list displaying mode is modified so as to be displayed in enlarged red characters, against other headlines. Such a change in the mode of displaying may entail at least a change in one of: the character size, the character color, and the character font.

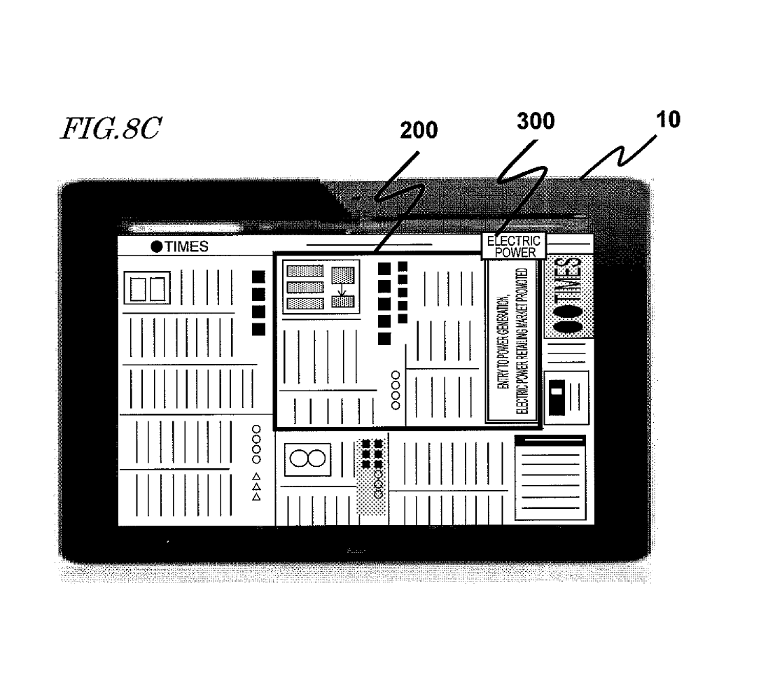

FIGS. 8A and 8B are diagrams each showing an exemplary displayed image after a change is made in the mode of displaying a newspaper image of an electronic newspaper on the display screen of the media tablet 10. FIG. 8A shows an example where, in the newspaper image displaying mode, the heading 100 “ENTRY TO POWER GENERATION, ELECTRIC POWER RETAILING MARKET PROMOTED” in a newspaper article is displayed in bold, green characters. FIG. 8B shows an example where an area 200 in a newspaper article under the heading “ENTRY TO POWER GENERATION, ELECTRIC POWER RETAILING MARKET PROMOTED” is displayed within a rectangular frame. Since such displaying places an emphasis on each article that is related to the breaking news selected by the user, the user can easily locate articles that are of interest to him or her.

Without being limited to the above example, the controller 16 may adopt the following, for example: a mode of displaying in which characters are flickered; a mode of displaying in which the background color is changed; a mode of displaying in which an article is surrounded by a frame; or a mode of displaying in which the article layout is changed. Alternatively, a mode of displaying which combines some of the aforementioned modes of displaying may be adopted. Possible examples of the control to be performed when changing the layout may involve moving any article that is related to the article selected by the user to a conspicuous position, and displaying only the related articles on one screen. The user may be allowed to designate which mode of displaying is to be adopted. Moreover, when the user has selected more than one breaking news article, the user may be allowed to separately designate a mode of displaying for each article.

When displaying a newspaper content on the display section 13 in an altered mode of displaying, the controller 16 may also allow the keyword which is associated with the article selected by the user to be together displayed, because it is possible that a user viewing the newspaper content may have forgotten which breaking news he or she has selected. Indicate the keyword 300 near the emphasized displaying as shown in FIG. 8C, for example, will help the user recall which breaking news he or she has selected.

Although the above description illustrates a case where the media tablet 10 generates the correspondence information and performs a process of changing the mode of displaying in accordance with the correspondence information, the system may be arranged so that these processes are performed at the web server 20. Hereinafter, a method will be described in which the web server 20 generates the correspondence information and generates a newspaper content which is edited so that a specific article will be displayed in a different mode of displaying in accordance with the correspondence information.

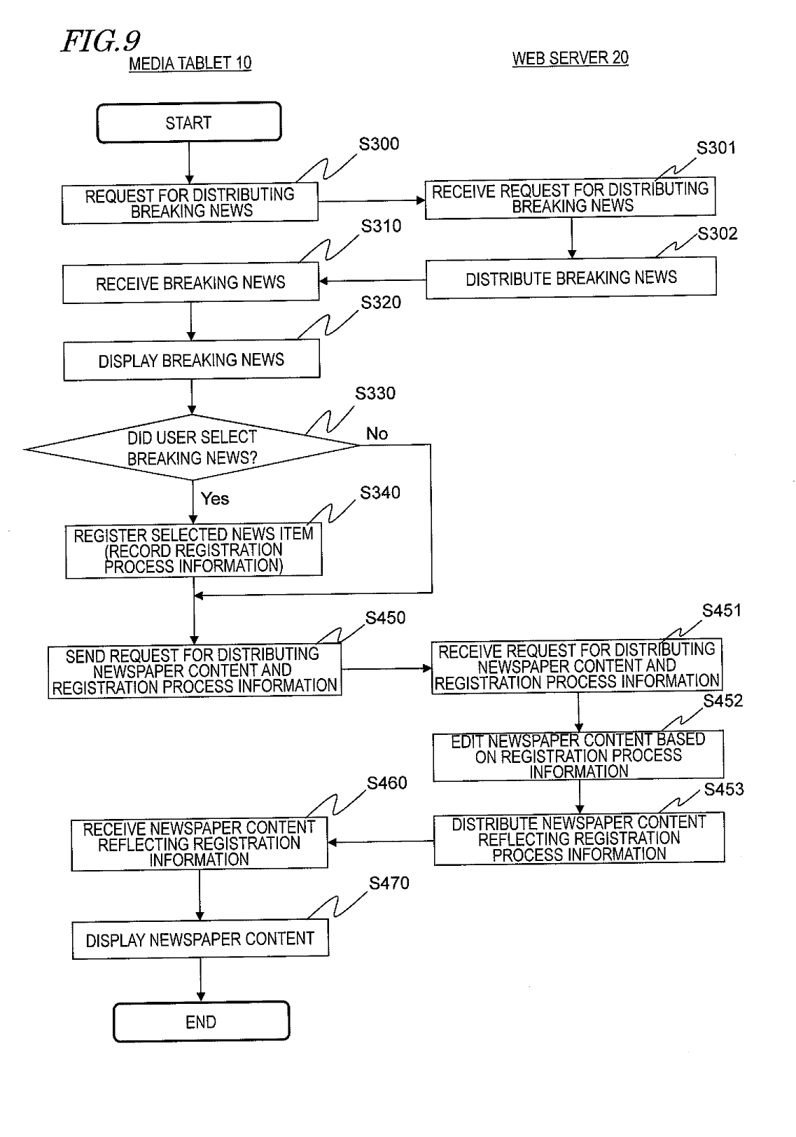

FIG. 9 is a flowchart showing another method of displaying an electronic newspaper with the media tablet 10 and the web server 20. In FIG. 9, identical steps to those in the flowchart of FIG. 3 are denoted by identical numerals. The difference from the flowchart of FIG. 3 is steps S450 to S470. Since steps S300 to S340 are identical to their counterparts in FIG. 3, descriptions thereof are omitted.

At step S450, the media tablet 10 sends to the web server 20 a request for distributing a newspaper content such as a morning edition or an evening edition, and also sends the registration process information generated at step S340 to the web server 20. As described above, the registration process information is a piece of information identifying an article which has interested the user among other breaking news articles. The registration process information contains information such as the article ID of the breaking news selected by the user, for example.

At step S451, the web server 20 receives the request for distributing a newspaper content and the registration process information. At the next step S452, based on the registration process information, the web server 20 edits the newspaper content. The editing process here is similar to the process which has been described with reference to FIGS. 5 through FIG. 8C.

For distribution of newspaper contents such as morning editions or evening editions, the distribution entity such as a newspaper company generates a newspaper content and stores it in the recording section 21 of the web server 20.

Upon receiving a request for distribution and the registration process information from the media tablet 10, the controller 22 of the web server 20 refers to the article ID which is contained in the registration process information, and identifies a keyword in the article associated with the article ID. The correspondence between article IDs and keywords is identifiable based on a database which is stored in the recording section 21 of the web server 20, for example. In the newspaper content waiting to be distributed, the controller 22 of the web server 20 searches for any articles the characters of whose headings contain an identical or similar keyword to the given keyword. If any relevant headline is found, as illustrated in FIG. 7, an HTML document is generated which produces a headline list of an electronic newspaper such that any headline related to the article of interest to the user receives a mode of displaying which is different from the mode of displaying of any other headline. Moreover, as illustrated in FIGS. 8A to 8C, an HTML document is generated which will result in a newspaper image of an electronic newspaper such that any article related to the article of interest to the user has a heading with characters in a changed color, size, etc., or is surrounded within a frame.

At step S453, the web server 20 distributes the aforementioned newspaper content, which reflects the registration process information, to the media tablet 10. At step S460, the network interface 11 of the media tablet 10 receives the newspaper content reflecting the registration process information. At step S470, the controller 16 of the media tablet 10 causes the display section 13 to display the received, newspaper content.

Through the above processes, as in the case of adopting the process shown in FIG. 3, the information of any newspaper content that is related to the article of the breaking news selected by the user is displayed in a mode of displaying which is different from that of any other information. This enables the user to easily locate articles of interest.

[1-3. Effects, etc.]

As described above, the information processing device (media tablet) 10 according to the present embodiment has a function of acquiring breaking news information that is distributed via the network 30 and newspaper article information (e.g., a morning edition or an evening edition) which is distributed after the breaking news information, and causing them to be displayed on a display (display section) 13. The media tablet 10 includes the network interface 11 for handling the communication of information via the network 30, and the controller 16 for causing the breaking news information and newspaper article information acquired by the network interface 11 to be displayed on the display section 13. While the breaking news information is being displayed on the display section 13, the controller 16 accepts from the user a selection of partial information that is contained in the breaking news information, and when allowing the subsequently-distributed newspaper article information to be displayed on the display section 13, ensures that any information related to the selected partial information within the newspaper article information is displayed in a mode of displaying which is different from that of any other information in the newspaper article information.

In particular, in the example shown in FIG. 3, the controller 16 of the media tablet 10 records registration process information indicating the partial information that has been selected by the user from among the breaking news to the storage medium (recording section 14), and based on this registration process information, searches the subsequently-distributed newspaper article information for any information that is related to the partial information selected by the user. Then, the information found is displayed on the display section 13 in an altered mode of displaying which is different from that of any other information.

Moreover, in the example shown in FIG. 9, the controller 16 of the media tablet 10 sends the registration process information indicating the partial information that has been selected by the user from among the breaking news to the web server 20, which is on a distributing end of the newspaper content, and receives from the web server 20 the newspaper article information which has been edited so that any information that is related to the partial information selected by the user will be displayed in a mode of displaying different from that of any other information on the display section 13. In this embodiment, based on the registration process information, the controller 22 of the web server 20 searches the newspaper article information waiting to be distributed for any information that is related to the partial information selected by the user, and the information found is edited into a format for being displayed in a mode of displaying different from that of any other information.

With the above configuration, the media tablet 10 is able to display articles within a newspaper content (e.g., a headline list or a newspaper image of a newspaper content) which are related (corresponding or similar) to breaking news that has been registered by the user, in a different mode of displaying from that of the other articles in the newspaper content. By noticing this altered mode of displaying, the user can readily locate the detailed articles which are related to the breaking news of interest to the user, from among the articles within the newspaper content. This reduces the burden associated with finding such articles of interest.

Moreover, according to the present embodiment, based on a newspaper content which is distributed after the arrival of breaking news, the newspaper content may be modified so that specific articles within the newspaper content which are related to the breaking news of interest to the user will receive a different mode of displaying from that of the other articles in the newspaper content. This modification may be performed at the user terminal (media tablet 10) side, or at the web server 20 side. Modifying the newspaper content at the web server 20 according to the user's interest will reduce processing burden at the user terminal.

Moreover, according to the present embodiment, the controller 16 of the media tablet 10 (in the example of FIG. 3) or the controller 22 of the web server 20 (in the example of FIG. 9) may search through the newspaper article information waiting to be distributed subsequently for any information that is identical or similar to a keyword which is associated with the partial information that has been selected by the user from among the breaking news, thereby identifying the information that is related to the partial information selected by the user. This allows the user to easily single out newspaper article information that is related to the breaking news of interest to him or her.

Moreover, the newspaper content in the present embodiment may contain information of an image of a page of an actual newspaper, which may be a morning edition or an evening edition. As a result, from within the actual page of a newspaper, the user can easily locate the related articles being displayed with emphasis, by using the media tablet 10.

Furthermore, the newspaper content may contain information representing a list of headlines of a morning edition or an evening edition. As a result, articles of interest can be readily located from within the newspaper content list that has been distributed.

In the present embodiment, information related to an article selected by the user may be displayed in a mode of displaying featuring characters which are changed in size, color, thickness, or font, a mode of displaying featuring characters which are flickered, a mode of displaying featuring an altered background color, a mode of displaying featuring a surrounding frame, and a mode of displaying featuring an altered layout, or a mode of displaying combining these, for example. Since information which is related to an article of interest to the user is displayed in a conspicuous mode of displaying, the user can readily locate the information of interest.

The present embodiment has illustrated a client-driven type approach (Smart-Pull type) where the user side makes a request for distribution of breaking news or an electronic newspaper to the web server 20. Alternatively, a server-driven approach (Real-Push type) may be adopted, where breaking news are distributed from the web server 20 at appropriate times, and electronic newspapers such as morning editions or evening editions are distributed at predetermined times.

Although the present embodiment contemplates a case of displaying breaking news and a subsequently-distributed newspaper content such as a morning edition or an evening edition, the technique according to the present disclosure is not limited to such examples. For instance, a similar process may be performed by using past newspaper contents, instead of the breaking news. In that case, the controller 16 of the media tablet 10 or the controller 22 of the web server 20 is arranged to: while displaying a past newspaper content, accept the user's selection of a partial article; and when displaying a subsequently-distributed newly-arrived newspaper content, display any article that is related to the article selected by the user in an altered mode of displaying different from that of the other articles.

It can be said that the information as to which article has been selected by the user is information indicating the interest of the user. Therefore, every time the user selects an article, the controller 16 of the media tablet 10 or the controller 22 of the web server 20 may accumulate the information of the selected article in the recording section 14 from day to day, and these may be reflected on subsequent displaying. In an example control, the frequency of selection by the user may be counted for each genre such as politics, financial, technology, social, and sports, and the next time when a newspaper content is displayed, the articles of any genre receiving a high frequency may be displayed in a manner which is automatically adjusted to be conspicuous. Through such control, without the user having to select an article of interest each time, articles which are inferred to be interesting to the user will be displayed in a conspicuous manner, thereby further promoting convenience.

Although the information processing device 10 is mainly described to be a media tablet in the present embodiment, it may be a PC, a smartphone, a mobile phone, or any other computer-mounted device. In the case where the information processing device 10 is a desktop PC, for example, the controller 16 displays an electronic document on a display which is connected to the information processing device 10; therefore, the display section 13 shown in FIG. 1 is not necessary.

Note that the configuration of the information processing device 10 shown in FIG. 1 and the like is exemplary; the information processing device 10 may be of any arbitrary configuration so long as the aforementioned functions are realized. The screen structure, table structure, data structure, flowcharts, etc., in the above description are also exemplary, and are subject to change as necessary. For example, in the screen of each embodiment, a button indication or the like for causing screen transitions may be provided.

### Other Embodiments

Thus, as an example of the technique which is disclosed in the present application, Embodiment 1 has been illustrated above. However, the techniques according to the present disclosure are not limited thereto, but accommodates embodiments in which changes, substitutions, additions, omissions, or the like are made as necessary. Moreover, it would be possible to combine the constituent elements described in Embodiment 1 above to obtain new embodiments. Accordingly, other embodiments will now be illustrated.

The information processing device of Embodiment 1 is described as displaying a newspaper article on the display. However, without being limited to newspaper articles, the configuration and operation of Embodiment 1 can be applied to any other type of document information (e.g., a book, a magazine, a journal, or other electronic contents). In that case, the description of Embodiment 1 should be interpreted so that the “breaking news” in the above description reads ‘first document information’ and the “newspaper content” reads ‘second document information’. In other words, the information processing device may be arranged so as to acquire first document information and subsequently-distributed second document information, each pieces of which is distributed through a network, and display the first and second document information on a display. As such, the information processing device includes a network interface for handling communication of information via a network, and a controller for causing the first and second document information acquired by the network interface to be displayed on the display. The controller may be arranged so as to, while the first document information is being displayed on the display, accept from the user a selection of partial information that is contained in the first document information, and while the subsequently-distributed second document information is being displayed on the display, cause information within the second document information that is related to the selected partial information to be displayed in a mode of displaying different from that of any other information within the second document information. As used herein, “document information” may be the data of any arbitrary content representing a document, as described above. The “document information” may be data of any format that is capable of expressing a document. As in a page of a newspaper image (FIG. 2D, etc.) described in Embodiment 1, other kinds of information such as images may be added to the first and second document information for distribution and displaying.

Moreover, as described earlier, a piece of information which is selected by a user may well represent the interest of the user. Therefore, by accumulating and then utilizing the information which is selected by the user, it is possible to construct an information provision system which provides various information on matters that are of interest to the user.

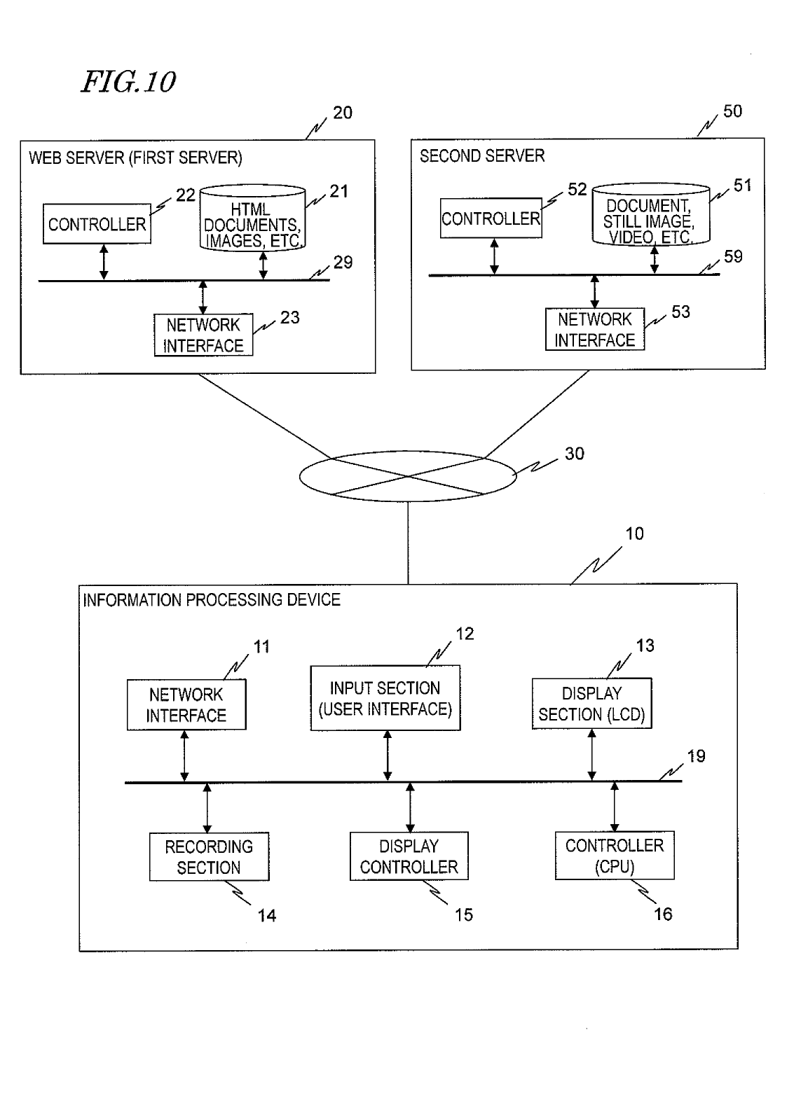

FIG. 10 is a diagram showing an exemplary configuration of such an information provision system. This system includes an information processing device 10, a web server (first server) 20 which distributes newspaper contents, and a second server 50 which provides another type of information. The information processing device 10 and the first server 20 are similar in configuration to the information processing device 10 and the web server 20 of Embodiment 1, respectively. The second server 50 has a similar configuration to that of the first server 20, except for including a recording section 51 which records information of a different type, e.g., a document, a still image, or a video, from the newspaper content. For example, the first server 20 may be a computer which is managed by a distribution entity such as a newspaper company, and the second server 50 may be a computer which is managed by the same distribution entity or a different distribution entity from that distribution entity.

In this system, in a manner similar to Embodiment 1, the first server 20 distributes breaking news and a newspaper content (such as a morning edition or an evening edition) to the information processing device 10. Furthermore, by accumulating and classifying the article information selected by the user of the information processing device 10, the first server 20 generates information which represents the presumed interest of the user (hereinafter referred to as “user's interest information”), and sends the information to the second server 50. Based on the user's interest information which is sent from the first server 20, the second server 50 generates and supplies information which is presumably of interest to the user (hereinafter referred to as “suggested information”).

The user's interest information generated by the first server 20 may be information of a collection of keywords that are associated with the articles which have hitherto been selected by the user, for example. Alternatively, it may be information which is obtained by classifying the information of the hitherto-accumulated keywords and ordering the user's interest for each genre, or score information which indicates the degree of user's interest for each genre. With such interest information, the second server 50 is able to identify the information which is presumably of interest to the user, and provide appropriate suggested information.

The suggested information which is generated by the second server 50 may be, for example, information which caters to the interest of the particular user, e.g., advertisements of books and magazines in the fields which are presumably of interest to the user, or advertisements of proposed travels to places which are presumably of interest to the user. Alternatively, it may be definitions of terminology concerning matters in which the user may be interested, information in encyclopedias, information of maps or videos, or hyperlinks to websites which provide such information. The first server 20 and the second server 50 cooperate to distribute such suggested information to the information processing device 10 in accordance with the newspaper information which is distributed from the first server 20.

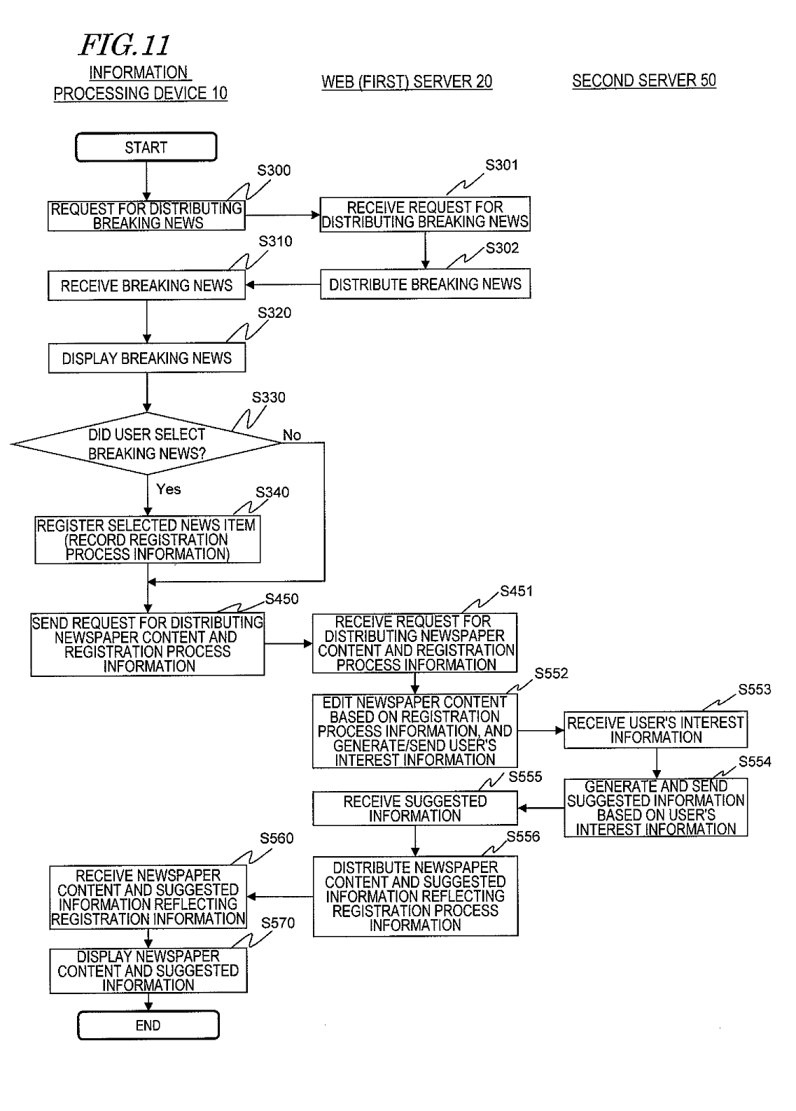

FIG. 11 is a flowchart showing an exemplary operation in this information provision system. The operation from steps S300 to S451 are identical to the operation in the corresponding steps in FIG. 9, and the description thereof is omitted. In this example, at step S552, the first server 20 edits the newspaper content based on the registration process information, and generates user's interest information also based on the registration process information, and sends the user's interest information to the second server 50. The generation of the user's interest information, which is based on the registration process information, may rely not only on the information of the currently selected article, but also on the entirety of the registration process information, which consists accumulations from a point in the past until the present. Upon receiving the registration process information at step S553, the second server 50 generates the suggested information based on the registration process information and sends it to the first server 20 at step S554. When the first server 20 receives the suggested information at step S555, the newspaper content and the suggested information reflecting the registration process information are distributed to the information processing device 10 at step S556. At step S560, the information processing device 10 receives the newspaper content and the suggested information. Then, at step S570, the newspaper content and the suggested information are displayed on the display screen.

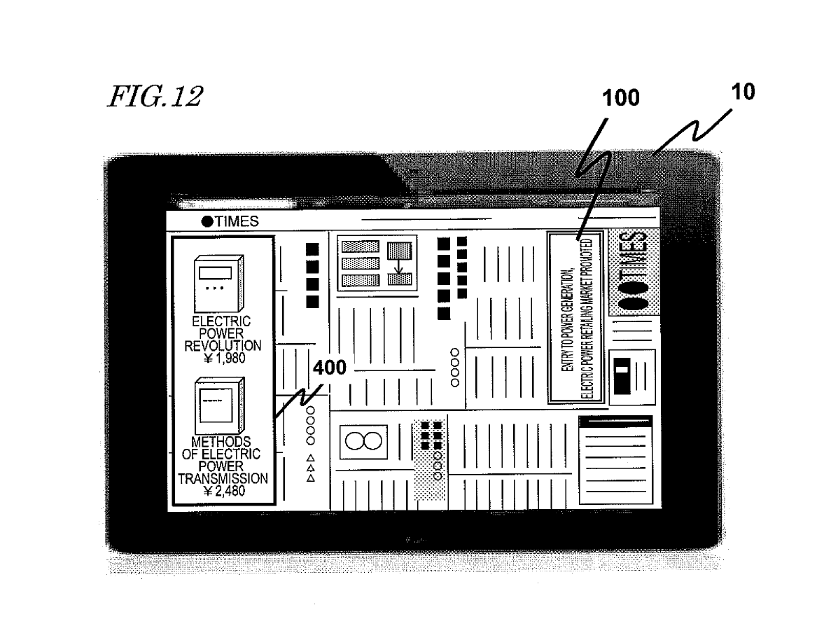

FIG. 12 is a diagram showing an example where suggested information 400 is displayed on the display screen of the information processing device 10 together with the newspaper content. In this example, the suggested information 400 concerning books that relate to “electric power”, in which the user shows interest, are displayed on the display screen together with the newspaper article information. When the user taps or clicks on the image of a specific book that is contained in the suggested information 400, a transition occurs to a website where that book is sold. This provides the user with opportunities to expand his or her knowledge with not only newspaper articles but also books.

In this example, the first server 20 distributes a newspaper content similarly to Embodiment 1. However, the first server 20 may distribute any document information other than a newspaper. For example, the first server 20 may be arranged to distribute an electronic document such as a book, a magazine, or a journal.

Moreover, in the flowchart shown in FIG. 11, the controller 22 of the first server 20 acquires the suggested information from a controller 52 of the second server 50, and distributes this together with the newspaper content to the information processing device 10. However, the first server and the second server 50 may independently distribute information to the information processing device 10. In that case, the controller 16 of the information processing device 10 may modify the newspaper content and the suggested information, respectively acquired from the first server 20 and the second server 50, into a format which allows them to be simultaneously displayed (e.g., an HTML file).

Furthermore, the manner in which the suggested information of FIG. 12 is displayed is only an example, and various modes of displaying would be possible for the suggested information. For example, the document information, suggested information, or other information which is presumably interesting to the user may be combined into one screen in a layout that is easy to see, or the suggested information alone may be displayed at the end of a document content so that it fits within one screen. Any arbitrary design may be adopted as to how the document information and the suggested information are displayed in combination.

Thus, the technique according to the present disclosure allows not only document contents such as newspaper articles, books, or magazines, but also various suggested information that caters to the interest of the user to be displayed on the screen. With such a system, whatever entity operating the second server 50 is able to obtain information indicating the user's interest from a newspaper company, publisher, or the like which operates the first server 20, thus being able to provide various suggested information to the user. As a result, the user is able to obtain various information of interest; and, as the user accesses a link in the suggested information, or purchases a commodity or service that is indicated by the suggested information, the entity which provides the suggested information can earn a profit. Moreover, in an arrangement where the entity providing the suggested information pays an advertisement charge to the newspaper company or the like, the newspaper company or the like can also earn profits. Thus, the technique of the present disclosure can be utilized to realize novel services which did not exist before.

Although the above example illustrates a case where the first server 20 and the second server 50 are distinct computers, an embodiment would also be possible where these servers are integrated. For example, a newspaper company and a travel agency which is related to that newspaper company may together operate a server as one entity. In that case, the system may be arranged so that newspaper contents and suggested information (e.g., travels) for the user are distributed from a single server to the information processing device 10.

The technique of the present disclosure is also applicable to software (program) that defines the processes in each of the above embodiments. The operation defined in such a program may be as shown in FIG. 3, 9, or 11, for example. Such a program may be provided in a recorded form on a portable storage medium, or provided via telecommunication lines. Various operations described in the above embodiments can be realized when such a program is executed by a processor which is internalized in a device.

Embodiments have been described above as an illustration of the technique of the present disclosure. The accompanying drawings and the detailed description are provided for this purpose.

Thus, elements appearing in the accompanying drawings and the detailed description include not only those that are essential to solving the technical problems set forth herein, but also those that are not essential to solving the technical problems but are merely used to illustrate the technique disclosed herein. Therefore, those non-essential elements should not immediately be taken as being essential for the reason that they appear in the accompanying drawings and/or in the detailed description.

The embodiments above are for illustrating the technique disclosed herein, and various changes, substitutions, additions, omissions, etc., can be made without departing from the scope defined by the claims and the equivalents thereof.

The technique of the present disclosure is applicable to a system including an information processing device which is capable of receiving document information and a distribution device which distributes document information. The information processing device may be suitably used in an information terminal such as a media tablet, a smartphone, or a personal computer, for example.

Moreover, a service which embodies the disclosed technique may be regarded as both a reservation service concerning matters to happen in the future and a suggestion service. Therefore, other than document information which is related to information of interest to a user, related information (various information with which an article or the like is generated) that an information distribution entity may possess can be utilized in realizing a novel service that provides various related information which is useful to the user.

While the present invention has been described with respect to exemplary embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2012-093623 filed on Apr. 17, 2012 and No. 2013-000499 filed on Jan. 7, 2013, the entire contents of which are hereby incorporated by reference.

What is claimed is:

1. An information processing device which acquires first document information and second document information distributed through a network and causes the first and second document information to be displayed on a display screen, the second document information being distributed after the first document information,
the information processing device comprising:
a network interface configured to perform communication of information via the network; and
a controller configured to cause the first and second document information acquired by the network interface to be displayed on the display screen,
wherein, while the first document information is being displayed on the display screen, the controller accepts from the user a selection of partial information contained in the first document information; and while the subsequently-distributed second document information is being displayed on the display screen, the controller causes information within the second document information that is related to the selected partial information, to be displayed in a mode of displaying different from that of any other information within the second document information.

2. The information processing device of claim 1, wherein the controller records registration process information representing the partial information selected by the user on a storage medium, and based on the registration process information, searches the second document information for information related to the partial information, and causes the information found to be displayed on the display screen in the altered mode of displaying different from that of any other information.

3. The information processing device of claim 2, wherein the controller identifies the information related to the partial information by searching the second document information for information that is identical or similar to a keyword associated with the partial information selected by the user.

4. The information processing device of claim 1, wherein the first and second document information contains information of a newspaper article.

5. The information processing device of claim 1, wherein the mode of displaying different from that of any other information is any one of: a mode of displaying featuring a character which is changed in size, color, thickness, or font; a mode of displaying featuring a character which is flickered; a mode of displaying featuring an altered background color; a mode of displaying featuring a surrounding frame; and a mode of displaying featuring an altered layout; or a combination thereof.

6. The information processing device of claim 1, wherein the controller sends registration process information representing the partial information selected by the user to a device on a distributing end of the second document information, receives from the device the second document information being edited so that the information related to the partial information is displayed in the mode of displaying different from that of any other information, and causes the second document information to be displayed on the display screen.

7. The information processing device of claim 1, wherein, while the second document information is being displayed on the display screen, the controller causes a keyword associated with the partial information selected by the user to be together displayed.

8. A method for controlling an information processing device, comprising:
acquiring a first document information;
displaying the first document information on the display screen attached to the information processing device;
while the first document information is being displayed on the display screen, accepting from the user a selection of partial information contained in the first document information;
receiving the second document information through the network; and
displaying the second document information on the display screen, wherein
the step of displaying the second document information comprises a step of displaying information within the second document information that is related to the selected partial information in a mode of displaying different from that of any other information within the second document information.

9. A distribution device comprising:
a network interface configured to handle communication of information via a network; and
a controller configured to distribute first document information and second document information to a plurality of information processing devices via the network interface, wherein
the controller is configured to, after distributing the first document information to the plurality of information processing devices, acquire registration process information from the information processing device, the registration process information representing partial information selected from within the first document information by the user of one of the plurality of information processing devices, and distribute the second document information to the information processing device, the second document information being edited so that information within the subsequently-distributed second document information that is related to the selected partial information is displayed in a mode of displaying different from that of any other information within the second document information.

10. The distribution device of claim 9, wherein the controller distributes suggested information for the user to the information processing device together with the edited second document information, the suggested information being generated based on the registration process information.
